(19) United States
(12) Patent Application Publication
(10) Pub. No.: US 2017/0227487 A1
(43) Pub. Date: Aug. 10, 2017

(54) Gas Sensor And Method For Detecting Oxygen

(71) Applicant: Siemens Aktiengesellschaft, Muenchen (DE)

(72) Inventors: Sabine Fischer, Ludwigsburg (DE); Maximilian Fleischer, Hoehenkirchen (DE); Erhard Magori, Feldkirchen (DE); Roland Pohle, Herdweg (DE); Nico Straub, Muenchen (DE)

(73) Assignee: Siemens Aktiengesellschaft, Muenchen (DE)

(21) Appl. No.: 15/328,332

(22) PCT Filed: Jul. 15, 2015
(86) PCT No.: PCT/EP2015/066120

§ 371 Date: Jan. 23, 2017

(30) Foreign Application Priority Data
Jul. 23, 2014 (DE) 102014214398.5

(51) Int. Cl. G01N 27/409

(52) U.S. Cl. CPC G01N 27/409

(57) ABSTRACT

The teachings of present disclosure may be embodied in gas sensors for detecting oxygen and methods for detecting oxygen in a gas mixture. For example, a gas sensor for detecting oxygen in a gas mixture may include: an oxygen ion conductor; at least two electrodes arranged on the oxygen ion conductor, the at least two of the electrodes arranged to come into contact with the gas mixture during operation of the gas sensor; a control device applying a polarization voltage or a polarization current to the at least two electrodes during a polarization period; a measuring device for measuring the current or the voltage at the at least two electrodes; and an evaluation device for calculating the oxygen content from the measured voltage or the measured current. Calculating the oxygen content may be based on: a current measured during the polarization period, or a charge which has flowed over the polarization period, or a voltage measured directly after the polarization period.

### CROSS-REFERENCE TO RELATED APPLICATIONS

This application is a U.S. National Stage Application of International Application No. PCT/EP2015/066120 filed Jul. 15, 2015, which designates the United States of America, and claims priority to DE Application No. 10 2014 214 398.5 filed Jul. 23, 2014, the contents of which are hereby incorporated by reference in their entirety.

### TECHNICAL FIELD

The present disclosure relates to sensors in general. The teachings thereof may be embodied in gas sensors for detecting oxygen and methods for detecting oxygen in a gas mixture.

### BACKGROUND

The measurement of oxygen in the exhaust gas plays a decisive role in combustion processes. Optimum combustion with low exhaust gas emissions can be achieved only with an accurately controlled oxygen/fuel ratio. The ratio is characterized by the variable λ (lambda) and the value λ=1. Even slight deviations from this result in greatly increased emissions of hydrocarbons or nitrogen oxides, depending on the direction of the deviation.

Setting the optimum operating point at λ=1 includes using the lambda probe in motor vehicles, where both a step-change probe and/or a broadband probe can be used. The operating point can be accurately determined in the step-change probe (ready for series production since 1976) on account of the large voltage change at exactly λ=1. The oxygen content, however, cannot be determined over a relatively wide oxygen range. At least for this reason, the broadband probe was put into series production in 1998, providing a virtually linear signal over a wide concentration range. Nowadays, every automobile is equipped with at least one oxygen sensor, often two oxygen sensors, in order to comply with the strict exhaust gas standards.

The oxygen sensors on the market have a very complex structure on account of their method of operation. The step-change probe requires a reference atmosphere with a constant oxygen content p_{O2}^{reference} at one electrode in order to measure the p_{O2}^{exhaustgas}-dependent Nernst voltage U_{Nernst}=RT/4F ln(p_{O2}^{exhaustgas}/p_{O2}^{reference}) For this reason, the production costs can be minimized only to a limited extent on account of the necessary reference channel (or a pumped reference). The broadband oxygen probe has a considerably more complex structure. In addition to a Nernst cell, a pump cell pumps oxygen into or out of a cavity with the aid of a pump voltage in order to ensure a defined O₂ content in the cavity (measured on the basis of a determined reference voltage U_{ref}=U_{Nernst}=450 mV using the Nernst cell). The oxygen content is determined using the pump current.

### SUMMARY

The teachings of the present disclosure may be embodied as gas sensors for detecting oxygen with a simplified structure as well as corresponding methods for detecting oxygen.

Some embodiments may include a gas sensor (10, 20) for detecting oxygen in a gas mixture, having an oxygen ion conductor (11) and at least two electrodes (12, 13) arranged on the oxygen ion conductor (11). At least two of the electrodes (12, 13) come into contact with the gas mixture during operation of the gas sensor (10, 20). The gas sensor may further include a control device (14) configured to apply a polarization voltage or a polarization current to the electrodes (12, 13) during a polarization period (82, 84, 86), a measuring device for measuring the current or the voltage at the electrodes (12, 13), and an evaluation device for determining the oxygen content from the measured voltage or the measured current. The evaluation device may determine the oxygen content from the current during the polarization period (82, 84, 86), in particular at the end of the polarization period, or the charge which has flowed over the polarization period (82, 84, 86), or the voltage directly after the polarization period (82, 84, 86).

Some embodiments may include a heating device (22) configured to heat the oxygen ion conductor (11) and the electrodes (12, 13) to at least 450° C., in particular at least 500° C.

Some embodiments may detect nitrogen oxides in the gas mixture.

Some embodiments may sequentially measure oxygen and nitrogen oxides and include a heating device configured to heat the oxygen ion conductor (11) and the electrodes (12, 13) to at least 450° C., in particular at least 500° C., during one or more oxygen measuring times comprising at least one sequence of polarization periods, and to heat the oxygen ion conductor (11) and the electrodes (12, 13) to a temperature at which oxygen ion conduction exists, in particular to between 350° C. and 450° C., during one or more nitrogen oxide measuring times consisting of one or more sequences of a polarization period (82, 84, 86) and a depolarization period (82, 84, 86).

Some embodiments may measure oxygen and nitrogen oxides in a parallel manner, and include a heating device configured to heat the oxygen ion conductor (11) and the electrodes (12, 13) to a temperature of between 350° C. and 450° C.

In some embodiments, the electrodes (12, 13) consist of the same material.

In some embodiments, the electrodes (12, 13) are in the form of interdigital electrodes (12, 13).

In some embodiments, there are three or more electrodes (12, 13) consisting of the same material and being arranged in such a manner that at least two of the electrodes come into contact with the gas mixture during operation of the gas sensor (10, 20).

In some embodiments, the oxygen ion conductor (11) is porous.

Some embodiments may include methods for detecting oxygen in a gas mixture, in which use is made of a gas sensor (10, 20) which comprises an oxygen ion conductor (11) and at least two electrodes (12, 13) arranged on this conductor. The gas sensor (10, 20) is connected to the gas mixture in such a manner that both electrodes (12, 13) come into contact with the gas mixture, a polarization voltage or a polarization current is applied to the electrodes (12, 13) during a polarization period (82, 84, 86). The current or the voltage at the electrodes (12, 13) is measured and the oxygen content in the gas mixture is determined from the measured voltage or the measured current. The oxygen content may be determined from the current during the polarization period (82, 84, 86), in particular at the end of the polarization period, or the charge which has flowed over the polarization period (82, 84, 86), or the voltage directly after the polarization period (82, 84, 86).

In some embodiments, the oxygen ion conductor (11) and the electrodes (12, 13) are held at a temperature of at least 450° C., in particular at least 500° C.

In some embodiments, the polarity of the applied voltage alternates in successive polarization periods.

In some embodiments, the depolarization period (82, 84, 86) is ended when an abort criterion is reached, in particular after expiry of a period which can be stipulated or when a voltage which can be stipulated is reached between the electrodes (12, 13).

In some embodiments, oxygen and nitrogen oxides are measured sequentially and the oxygen ion conductor (11) and the electrodes (12, 13) are heated to at least 450° C., in particular at least 500° C., during one or more oxygen measuring times comprising a sequence of polarization periods and a depolarization period (82, 84, 86), and the oxygen ion conductor (11) and the electrodes (12, 13) are heated to a temperature at which oxygen ion conduction exists, in particular to between 350° C. and 450° C., during one or more nitrogen oxide measuring times consisting of one or more sequences of a polarization period (82, 84, 86) and a depolarization period (82, 84, 86).

In some embodiments, oxygen and nitrogen oxides are measured in a parallel manner and the oxygen ion conductor (11) and the electrodes (12, 13) are heated to a temperature of between 350° C. and 450° C.

In some embodiments, the content of nitrogen oxides in the gas mixture is determined in the nitrogen oxide measuring times, and the voltage or the current between the electrodes (12, 13) in the depolarization period (82, 84, 86), in particular at the end of the depolarization period (82, 84, 86), is determined as the measurement signal for this purpose.

### BRIEF DESCRIPTION OF THE DRAWINGS

The teachings of the present disclosure are described below using exemplary embodiments and with reference to the figures.

FIG. 1 shows the oxygen-dependent polarization current for different oxygen concentrations, according to teachings of the present disclosure.

FIG. 2 shows signals which represent the charge transferred during a respective polarization period for different oxygen concentrations and different temperatures of the gas sensor, according to teachings of the present disclosure.

FIG. 3 shows the profile of the voltage during depolarization for different oxygen concentrations, according to teachings of the present disclosure.

FIG. 4 shows the first 500 ms of the profile, in which it becomes visible that the oxygen concentration influences the voltage directly at the beginning of the depolarization period, according to teachings of the present disclosure.

FIG. 5 schematically shows a first variant of a gas sensor having two electrodes, according to teachings of the present disclosure.

FIG. 6 schematically shows a side view of a second variant of a gas sensor having interdigital electrodes, according to teachings of the present disclosure.

FIG. 7 schematically shows the electrode structure of the second variant of a gas sensor having interdigital electrodes, according to teachings of the present disclosure.

FIG. 8 schematically shows a diagram for a first measuring method, according to teachings of the present disclosure.

FIG. 9 schematically shows a diagram for a second measuring method, according to teachings of the present disclosure.

FIG. 10 schematically shows a diagram for a third measuring method, according to teachings of the present disclosure.

### DETAILED DESCRIPTION

The teachings of the present disclosure may be embodied in gas sensors for detecting oxygen in a gas mixture. Some sensors may comprise an oxygen ion conductor and at least two electrodes arranged on the oxygen ion conductor. Both electrodes may come into contact with the gas mixture during operation of the gas sensor. The gas sensor may comprise a control device configured to apply a polarization voltage or a polarization current to the electrodes during a polarization period, a measuring device for measuring the current or the voltage at the electrodes, and an evaluation device for determining the oxygen content from the measured voltage or the measured current. The oxygen content may be determined from the current during the polarization period, in particular at the end of the polarization period, the charge which has flowed over the polarization period, and/or the voltage directly after the polarization period.

In some methods using the teachings of the present disclosure, a gas sensor comprises an oxygen ion conductor and at least two electrodes arranged on this conductor, and the gas sensor is connected to the gas mixture in such a manner that both electrodes come into contact with the gas mixture. A polarization voltage or a polarization current is then applied to the electrodes during a polarization period, and the current or the voltage at the electrodes is measured, and the oxygen content in the gas mixture is determined from the measured voltage or the measured current. In this case, the oxygen content is determined from the current during the polarization period, in particular at the end of the polarization period, or the charge which has flowed over the polarization period, or the voltage directly after the polarization period.

In contrast with nitrogen oxide detection, the current during polarization I_{Pol}(t), rather than the depolarization voltage after a depolarization time in the region of 1 s, can be primarily used to detect the influence of oxygen. The current at the end of the polarization period is therefore greatly dependent on the oxygen content. In this case, it should be noted that the O²⁻ ion conductivity is determined by the Y2O3 doping content of the ZrO2 substrate and the temperature and is not dependent on the oxygen content of the atmosphere. Therefore, the oxygen dependence of the polarization current must have a different cause.

At low temperatures of up to 400° C., the ionic conductivity of the YSZ substrate is low; this results in only a particular oxygen ion current I=U/R_{YSZ} transported by the ion conductor irrespective of the oxygen available at the three-phase boundary. No oxygen influence on the polarization current can therefore be measured with this low ion conductivity and high substrate resistance R_{YSZ}.

The conductivity increases exponentially with increasing temperature. Therefore, above 400° C., the ion conductivity is large enough for the formation of ions at the three-phase boundary O₂+4e⁻→2O²⁻ to limit the ion current and, on account of the high ion conductivity at these temperatures, for all ions formed to also be transported from one electrode to the other through the substrate. That is to say, the more oxygen is delivered at the platinum electrode, the more ions can be transported. Therefore, the oxygen dependence of the current during polarization at high temperatures can be explained.

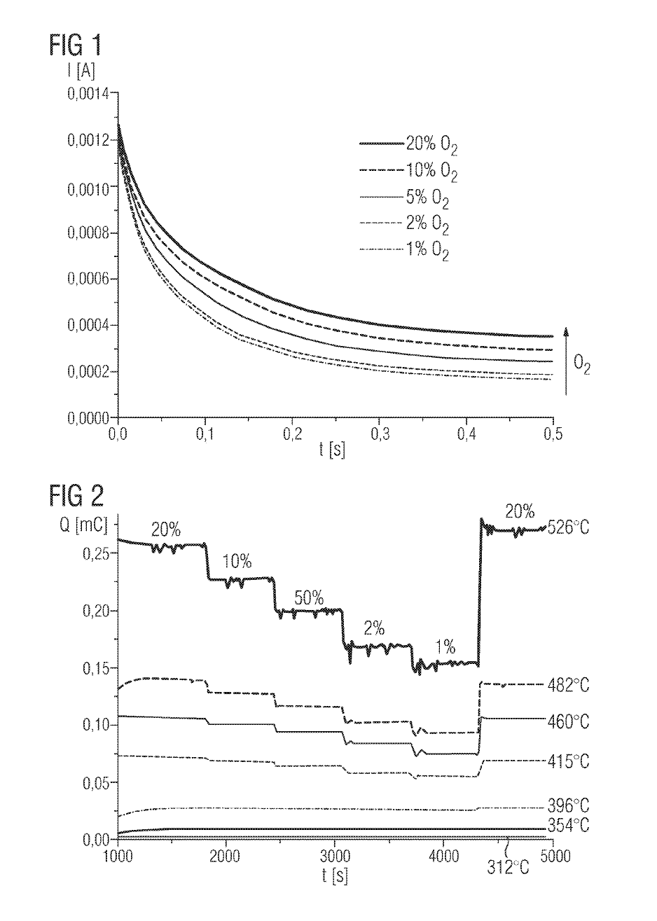

This dependence is illustrated as the result of an exemplary measurement in FIG. 1. On account of a symmetrical electrode arrangement on the ion conductor, the measuring effect is identical in both polarization directions. FIG. 1 shows the oxygen-dependent polarization current for different oxygen concentrations. FIG. 2 shows signals which represent the charge transferred during a respective polarization period for different oxygen concentrations and different temperatures of the gas sensor.

The polarization current exhibits a clear oxygen dependence, in particular at the end of polarization. An increasing oxygen pump current results with increasing oxygen content. Whereas charging effects (corresponding to charging of an RC element) and additional redox reactions (such as platinum oxidation and reduction of platinum oxides) also cause a current increase at the beginning of polarization, the transport of oxygen in the form of O²⁻ ions through the ion conductor can be measured on the basis of the stationary current component at the end of polarization on the basis of the applied potential.

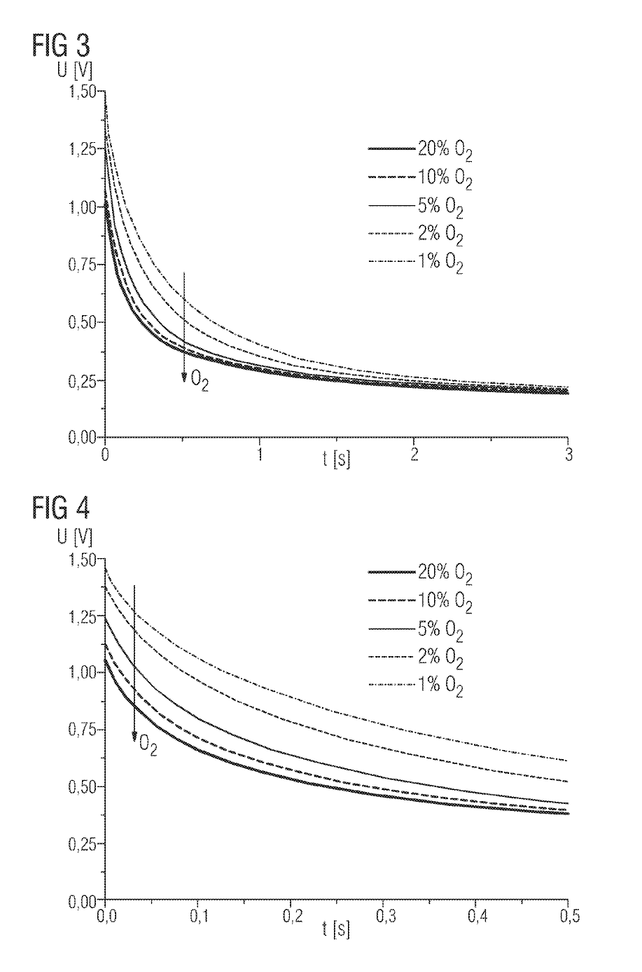

In addition to this very good correlation between the current or the charge during polarization and the oxygen concentration, the result is also a considerable influence of the oxygen on the depolarization period which respectively follows the polarization period. In this case, a strong effect on the voltage, in particular, can be measured directly at the beginning of depolarization: the measured voltage falls at this time with increasing oxygen content, whereas a virtually oxygen-independent depolarization voltage is achieved at the end of depolarization, that is to say after 3 s. Whereas the voltage is 1.43 V directly after 2 V polarization of the platinum electrodes with 1% oxygen, the polarizability is considerably lower at higher O2 concentrations, with the result that a voltage of only 1.07 V is measured directly at the beginning of discharge with 20% oxygen. These properties are illustrated in FIGS. 3 and 4. FIG. 3 shows the profile of the voltage during depolarization for different oxygen concentrations. FIG. 4 shows the first 500 ms of the profile, in which it becomes visible that the oxygen concentration influences the voltage directly at the beginning of the depolarization period. The temperature of the gas sensor is 526° C. during these measurements.

The oxygen content of the surrounding gas mixture can therefore be detected as taught using a sensor with a comparatively simple structure. It is no longer necessary to configure the structure in such a manner that one of the electrodes is in contact with a reference gas and is isolated from the gas mixture to be measured. Since the reference gas is usually the ambient air, an access for the ambient air to an inner side in the form of a chamber in the zirconium oxide is created, for example, for this purpose in the prior art, which gives rise to considerable effort during production. In addition to the more favorable production, for example by means of planar technology, it is therefore also possible to save on expensive raw materials. Furthermore, the sensor has a much better potential for being very small.

The teachings can be used to determine the oxygen concentrations in applications in which the supply of the reference gas required for conventional sensors is not possible. The sensor can therefore make it possible to measure the oxygen inside the exhaust gas section of large combustion installations.

The gas sensor may have a heating device configured to heat the oxygen ion conductor and the electrodes to at least 450° C., in particular at least 500° C. For example, an electrical resistance heater may be provided here, for example in the form of a platinum conductor loop implemented using thick-film or thin-film technology. The conductor loop may be simultaneously used as a temperature sensor. Alternatively, there may be an additional conductor as a temperature sensor. The control device is expediently designed to adjust the heating device during operation of the gas sensor in such a manner that the gas sensor has a temperature of at least 450° C., in particular at least 500° C. or even at least 550° C.

The electrodes can consist of the same material. This simplifies the production of the sensor. Measurements have shown that particular gases can also be detected using identical electrodes if both electrodes are exposed to the gas mixture to be measured.

The electrodes may be in the form of interdigital electrodes. This improves the signal quality.

The gas sensor may detect nitrogen oxides in the gas mixture. For this purpose, the heating device may heat the oxygen ion conductor and the electrodes to at least 450° C., in particular at least 500° C. or at least 550° C., during one or more oxygen measuring times comprising a sequence of polarization periods, and to heat the oxygen ion conductor and the electrodes to a temperature at which oxygen ion conduction exists, in particular to between 350° C. and 450° C., during one or more nitrogen oxide measuring times consisting of one or more sequences of a polarization period and a depolarization period. Depending on the temperature of the gas mixture in which the gas sensor is embedded, there may be no need for heating in the nitrogen oxide measuring times, but rather the sensor is already at a sufficient temperature as a result of the ambient temperature.

The teachings may provide a gas sensor which can measure not only oxygen but also nitrogen oxides using only one sensor element. The gas sensor may have more than two, in particular three or four, electrodes, the electrodes arranged to come into contact with the gas mixture during operation of the gas sensor. In this case, two of the electrodes, for example, may be arranged on one side of the ion-conducting material, while the third electrode or the third and fourth electrodes is/are arranged on the other side of the ion-conducting material. A voltage may be impressed during a respective polarization period for the different pairs of electrodes with a time offset, in other words, in a phase-shifted manner. A measuring point is therefore produced more often and the temporal resolution is therefore improved. Alternatively or additionally, pairs of electrodes may be connected in series and an improvement in the signal swing can therefore be achieved.

The oxygen ion conductor may be porous. In the case of a sensor from the prior art in which the ion-conducting material adjoins both the gas mixture to be measured and ambient air, for example, the gradients in the partial pressure of the various gases result in the gases being diffused through the ion-conducting material, which results in a deterioration in the sensor signal. Since the ion-conducting material no longer adjoins the ambient air in the case of the present sensor, but rather is expediently surrounded on all sides by the gas to be measured or a solid body, such diffusion no longer occurs and a porous material, in particular an open-pore material, can be used. A porous ion-conducting material can advantageously be produced more easily, is more stable to the loads caused by changing temperatures and has a higher specific surface area, which entails advantages for the interaction with gases and therefore for the sensor signal.

The polarity of the applied voltage can alternate in successive polarization periods. In other words, a polarization period in which a positive voltage is applied to the electrodes is followed, after the associated depolarization period, by a polarization period in which a negative voltage is applied to the electrodes and vice versa.

Before a polarization period, the electrodes can be temporarily short-circuited in order to reduce residual voltage from the preceding polarization. Short-circuiting is expediently carried out if the same polarity of the applied voltage is used in successive polarization periods.

Each depolarization period is expediently ended when an abort criterion is reached, in particular after expiry of a period which can be stipulated or when a voltage which can be stipulated is reached between the electrodes. In the nitrogen oxide measuring times, the content of nitrogen oxides in the gas mixture can be determined and the voltage or the current between the electrodes in the depolarization period, in particular at the end of the depolarization period, can be determined as the measurement signal for this purpose. If the reaching of a stipulatable abort voltage in terms of magnitude is used as the abort criterion, the time within the depolarization period until the abort criterion is reached can be used as the measurement signal.

The gas sensor may comprise electrical connections to the electrodes and means for applying a voltage to the electrodes as well as a device for measuring the voltage between the electrodes during the subsequent depolarization.

The ion-conducting material may be yttrium-stabilized zirconium oxide (YSZ), for example. It may act as the carrier for the electrodes. Alternatively, it is also possible for the ion-conducting material to be applied as a layer to a carrier, for example made of aluminum oxide. The electrodes are then expediently in turn applied to the layer made of the ion-conducting material. The electrodes themselves are expediently made of platinum.

In order to measure nitrogen, a voltage may be applied to the pair of electrodes for a stipulatable first period of preferably between 0.1 s and 1 s, in particular 0.5 s. The discharge is then observed for a second period and the voltage is recorded. The voltage level after a period of 3 s, for example, is then the sensor signal. This operation is then repeated. In some embodiments, the polarity of the voltage applied in the first period is alternately changed.

FIG. 5 is a schematic illustration showing a first gas sensor 10 according to one embodiment. This gas sensor comprises a block 11 made of YSZ material. The block 11 has a thickness of 0.25 mm and a width and depth of 5 mm. A first platinum electrode 12 is arranged on a first side of this block 11, whereas a second platinum electrode 13 is applied to a second side opposite the first side. The platinum electrodes 12, 13 are electrically connected to a device 14 for generating and measuring voltage and/or current. FIG. 5 does not illustrate means which can be used to introduce the first gas sensor 10 into a space filled with the gas mixture to be measured, for example a flange for screwing into a correspondingly configured opening. These means and the gas sensor 10 are configured in such a manner that, after the gas sensor 10 has been fitted, both the first platinum electrode 12 and the second platinum electrode 13 are in direct contact with the gas mixture. In contrast, contact between the block 11 and the ambient air, for example, may be avoided in this case.

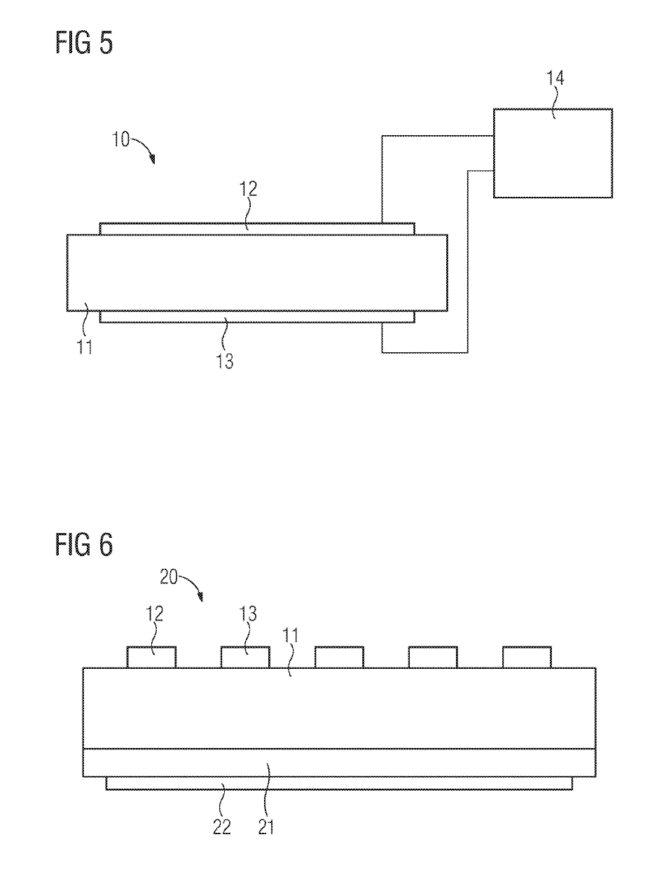

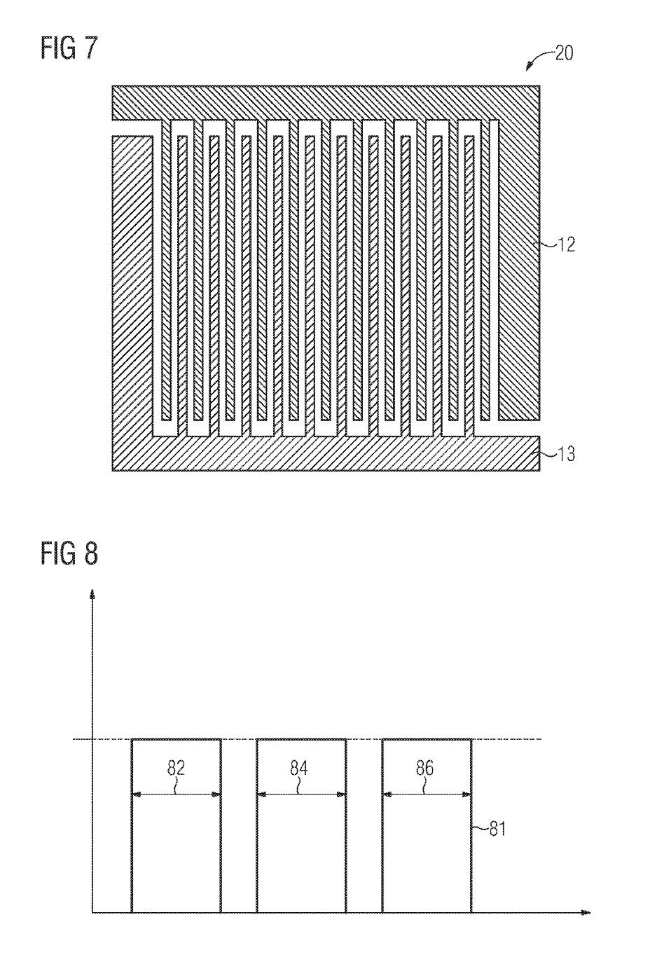

FIGS. 6 and 7 show a second gas sensor 20 according to another embodiment. The second gas sensor 20 comprises a block 11 made of YSZ material. In the case of the second gas sensor 20, the block 11 has a thickness of 150 μm, a width of 5 mm and a depth of 6 mm. In contrast with the first gas sensor 10, both the first platinum electrode 12 and the second platinum electrode 13 are now arranged on a first side of this block 11. These electrodes are in the form of interdigital electrodes, that is to say with fingers which engage in one another. They are again connected to the outside via platinum wires having a thickness of 100 μm.

In the case of the second gas sensor 20, a layer 21 for electrical insulation is applied to the second side opposite the first side. A heating structure 22 consisting of platinum is in turn arranged on this layer. The second gas sensor 20 can be heated using this structure. On the one hand, the heating structure 22 itself can be used for temperature control. In some embodiments, an additional temperature sensor is used.

Possible forms of operation for the gas sensors 10, 20 are schematically shown in FIGS. 8 to 10 using voltage/time graphs.

In a first form of operation according to FIG. 8, a voltage is applied to the platinum electrodes 12, 13 during operation of the gas sensor 10 by means of the device 14 during pulse periods 82, 84, 86. The electrodes 12, 13 are short-circuited between the pulse periods 82, 84, 86 in order to reset the voltage between them and enable a new measurement without influence. During the pulse periods 82, 84, 86, the flowing current is measured at at least one time and is summed (in the case of a plurality of times) in order to determine the flowing charge which is a measure of the oxygen content of the surrounding gas mixture.

In this case, the gas sensor 10, 20 is ideally kept at a temperature of 500° C. or more, in particular 520° C., in order to measure the oxygen. This can be carried out by means of the heating structure 22 provided that the surrounding gas mixture does not itself ensure a corresponding temperature.

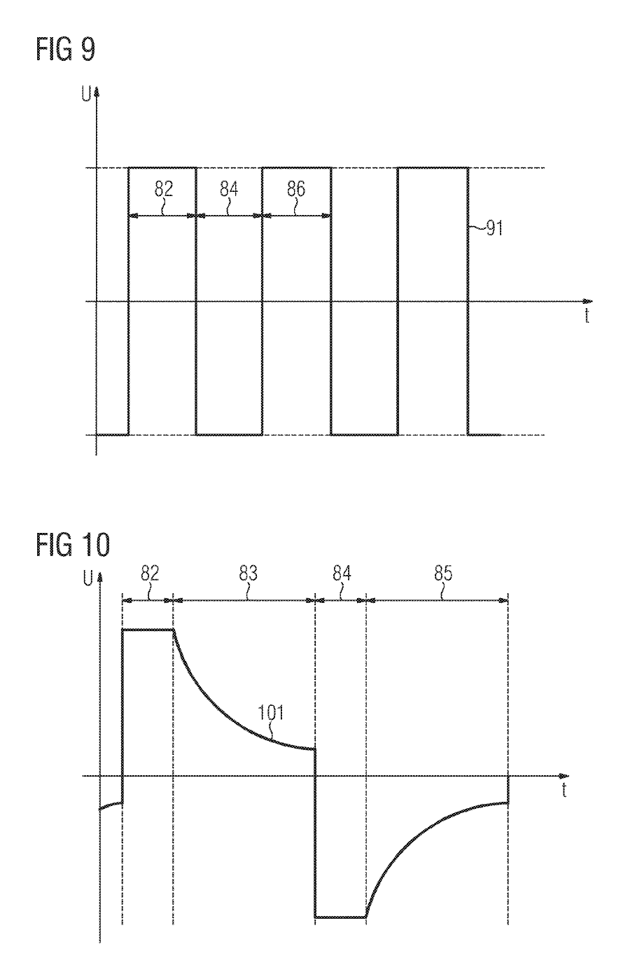

FIG. 9 shows a second form of operation. In this measuring method, a voltage corresponding to the voltage curve 91 illustrated in FIG. 9 is applied to the electrodes 12, 13. In this case, a voltage of equal amplitude but changing polarity is respectively applied in the successive pulse periods 82, 84, 86. This makes it possible to dispense with the short-circuiting of the electrodes 12, 13. In a similar manner to the first form of operation, the flowing current is measured at at least one time during the pulse periods 82, 84, 86 and is summed (in the case of a plurality of times) in order to determine the flowing charge which is again a measure of the oxygen content of the surrounding gas mixture.

FIG. 10 illustrates a third form of operation. In this case, depolarization periods 83, 85 in which a voltage is not applied to the electrodes are situated between successive pulse periods 82, 84, 86. This form of operation is unnecessary for the pure measurement of oxygen and extends the times between measurement signals for the oxygen concentration. If, however, the intention is to also measure the presence of nitrogen oxides in addition to the oxygen concentration, the third form of operation is expedient for measuring nitrogen oxides. In this case, the voltage at the end of a respective depolarization period 83, 85, for example, is used as the measurement signal for the concentration of nitrogen oxides.

In this case, it is possible to change between operation as an oxygen sensor and operation as a nitrogen oxide sensor. In this case, operation as a nitrogen oxide sensor comprises one or more sequences of pulse periods 82, 84, 86 and depolarization periods 83, 85 in which the temperature of the gas sensor is kept at 350° C., for example. Operation as an oxygen sensor comprises a sequence of pulse periods 82, 84, 86 corresponding to the first or second form of operation. Alternatively, during operation as an oxygen sensor, the third form of operation can likewise be used if the depolarization periods 83, 85 are also not used in this case. During operation as an oxygen sensor, the temperature of the gas sensor 10, 20 is kept at 500° C. or more.

Alternatively, oxygen and nitrogen oxides can also be measured in a parallel manner. In this case, a suitable temperature for the gas sensor, which allows both measurements, is stipulated. In this case, operation of the gas sensor comprises one or more sequences of pulse periods 82, 84, 86 and depolarization periods 83, 85.

What is claimed is:

1. A gas sensor for detecting oxygen in a gas mixture, the gas sensor comprising:
an oxygen ion conductor; and
at least two electrodes arranged on the oxygen ion conductor, the at least two of the electrodes arranged to come into contact with the gas mixture during operation of the gas sensor;
a control device applying a polarization voltage or a polarization current to the at least two electrodes during a polarization period;
a measuring device for measuring the current or the voltage at the at least two electrodes; and
an evaluation device for calculating the oxygen content from the measured voltage or the measured current;
wherein calculating the oxygen content is based at least in part on one of:
a current measured during the polarization period, or
a charge which has flowed over the polarization period, or a
voltage measured directly after the polarization period.

2. The gas sensor as claimed in claim 1, further comprising a heating device to heat the oxygen ion conductor and the at least two electrodes to at least 450° C.

3. The gas sensor as claimed in claim 2, which is additionally configured to detect nitrogen oxides in the gas mixture.

4. The gas sensor as claimed in claim 3, configured to sequentially measure oxygen and nitrogen oxides;
wherein the heating device:
heats the oxygen ion conductor and the at least two electrodes to at least 450° C. during one or more oxygen measuring times comprising at least one sequence of polarization periods, and
heats the oxygen ion conductor and the electrodes to between 350° C. and 450° C. during one or more nitrogen oxide measuring times consisting of one or more sequences of a polarization period and a depolarization period.

5. The gas sensor as claimed in claim 3, configured to measure oxygen and nitrogen oxides in a parallel manner, wherein the heating device heats the oxygen ion conductor and the at least two electrodes to a temperature of between 350° C. and 450° C.

6. The gas sensor as claimed in claim 1, wherein the at least two electrodes each consist of the same material.

7. The gas sensor as claimed in claim 1, wherein the at least two electrodes comprise interdigital electrodes.

8. The gas sensor as claimed in claim 1, further comprising three or more electrodes each consisting of the same material and arranged so that at least two of the electrodes come into contact with the gas mixture during operation of the gas sensor.

9. The gas sensor as claimed in claim 1, wherein the oxygen ion conductor comprises a porous material.

10. A method for detecting oxygen in a gas mixture, wherein
a gas sensor which comprises an oxygen ion conductor and at least two electrodes arranged on the oxygen ion conductor, the method comprising:
connecting the gas sensor to the gas mixture so that the at least two electrodes come into contact with the gas mixture;
applying
a polarization voltage or a polarization current to at least two electrodes during a polarization period;
measuring the current or the voltage at the electrodes; and
calculating the oxygen content in the gas mixture based on the measured voltage or the measured current;
wherein the oxygen content is calculating based on one or more of the following:
a current measured during the polarization period, or a
charge which has flowed over the polarization period, or
a voltage measured directly after the polarization period.

11. The method as claimed in claim 10, further comprising holding the oxygen ion conductor and the at least two electrodes at a temperature of at least 450° C.

12. The method as claimed in claim 10, further comprising alternating a polarity of the applied polarization voltage in successive polarization periods.

13. The method as claimed in claim 10, further comprising ending the depolarization period when an abort criterion is reached, the abort criterion comprising expiry of a stipulated period or reaching a stipulated voltage between the electrodes.

14. The method as claimed in claim 10, further comprising:
measuring oxygen and nitrogen oxides sequentially;
heating
the oxygen ion conductor and the at least two electrodes to at least 450° C. during one or more oxygen measuring times comprising a sequence of polarization periods and a depolarization period; and
heating the oxygen ion conductor and the at least two electrodes to a temperature between 350° C. and 450° C. during one or more nitrogen oxide measuring times consisting of one or more sequences of a polarization period and a depolarization period.

15. The method as claimed in claim 10, further comprising measuring oxygen and nitrogen oxides in a parallel manner and heating the oxygen ion conductor and the at least two electrodes to a temperature of between 350° C. and 450° C.

16. The method as claimed in claim 14, further comprising determining the content of nitrogen oxides in the gas mixture during the nitrogen oxide measuring times based on a voltage or a current between the electrodes in the depolarization period.
